(19) United States
(12) Patent Application Publication
(10) Pub. No.: US 2005/0083177 A1
(43) Pub. Date: Apr. 21, 2005

(54) Communications unit

(76) Inventor: Mikael Willgert, Spanga (SE)

Correspondence Address: ALFRED J MANGELS, 4729 CORNELL ROAD, CINCINNATI, OH, 452412433, US

(21) Appl. No.: 10/495,449

(22) PCT Filed: Nov. 6, 2002
(86) PCT No.: PCT/SE02/02025

(30) Foreign Application Priority Data
Nov. 13, 2001 (SE) 0103762-1

(51) Int. Cl. H04Q 5/22

(52) U.S. Cl. 340/10.1

(57) ABSTRACT

A communications unit for identifying objects or persons. The unit includes a receiver/transmitter unit that is operable in accordance with the so-called Bluetooth communications system, and a transponder operable in accordance with the so-called RFID system. The transponder is integrated with the receiver/transmitter unit in a manner to enable components associated with the receiver/transmitter unit to be used also for transponder operation.

### BACKGROUND OF THE INVENTION

1. Field of the Invention

The present invention relates to a communications unit.

2. Description of the Related Art

Known automatic identification systems that use radio frequencies, so-called RFID (Radio Frequency Identification), include identification tags (ID tags) and communicators. Each identification tag includes an antenna, a modulator, and a control logic circuit for controlling the modulator. One such ID tag is designed to receive a signal sent by a communicator and to reflect this signal in a modulated state.

The ID tag is affixed to the object or to the person that is to be identified. The identity can be read by a communicator at a given short distance, for example of five meters. Depending on the design, it is also possible, in addition to reading an identity, to read and write other information from and into the ID tag, respectively, with the aid of the communicator.

The relatively short range of, e.g., five meters, makes it possible to communicate with the ID tags within a geographically limited communications area.

For the same reason, identification that is based solely on so-called Bluetooth technology is less suitable, since the communications area is large. A typical occurrence is that the power received by the communicator in an RFID system decreases with the distance R=1/R⁴, whereas the corresponding power in a Bluetooth system decreases with the distance R=1/R².

However, an ID system is highly usable per se, as is also a Bluetooth system per se. Consequently, it is often necessary for a user to have access to both systems for different applications. Naturally, this results in higher costs than when only one of the systems is used. Moreover, it is, of course, troublesome for a user to carry two systems on his/her person.

The present invention solves this problem and provides a solution to this problem that significantly lowers the costs and affords simpler handling.

### SUMMARY OF THE INVENTION

The present invention thus relates to an object or person identification communications unit. The unit includes a receiver/transmitter unit according to a so-called Bluetooth system, and a transponder according to a so-called RFID system. The transponder is integrated with the receiver/transmitter unit such as to enable components associated with said receiver/transmitter unit to be used also for transponder operation.

### BRIEF DESCRIPTION OF THE DRAWINGS

The invention will now be described in more detail, partly with reference to an exemplifying embodiment thereof shown in the accompanying drawings, in which

FIG. 1 illustrates a first embodiment of the invention; and

FIG. 2 illustrates a second embodiment of the invention.

### DESCRIPTION OF THE PREFERRED EMBODIMENTS

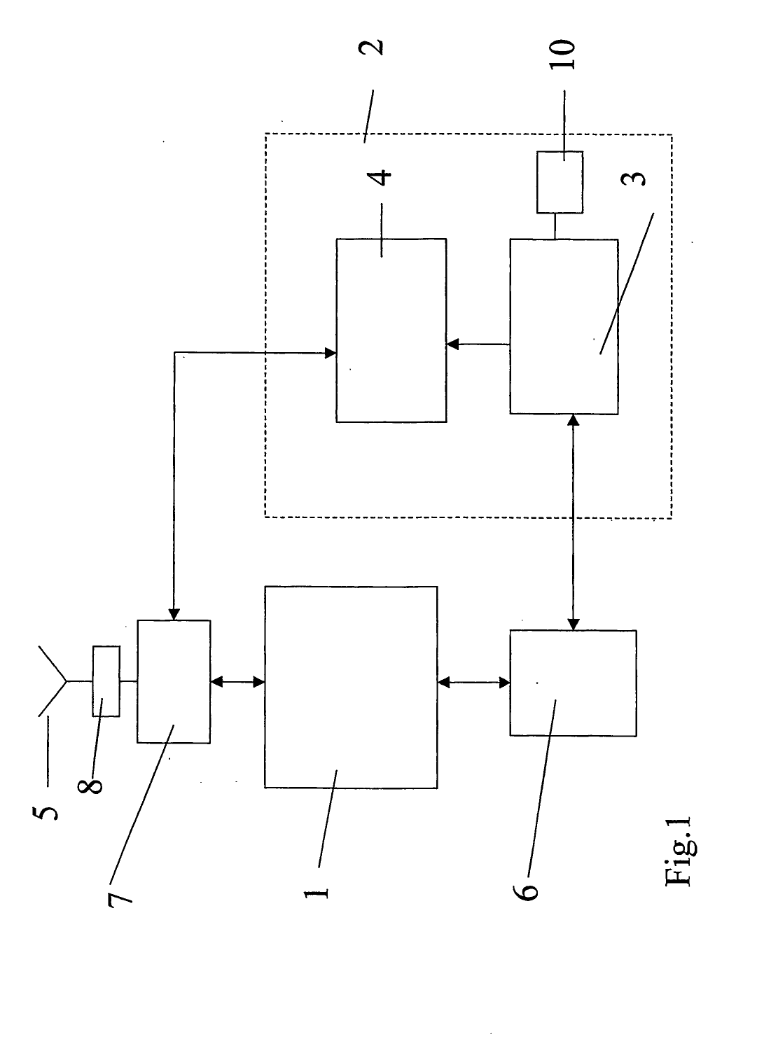

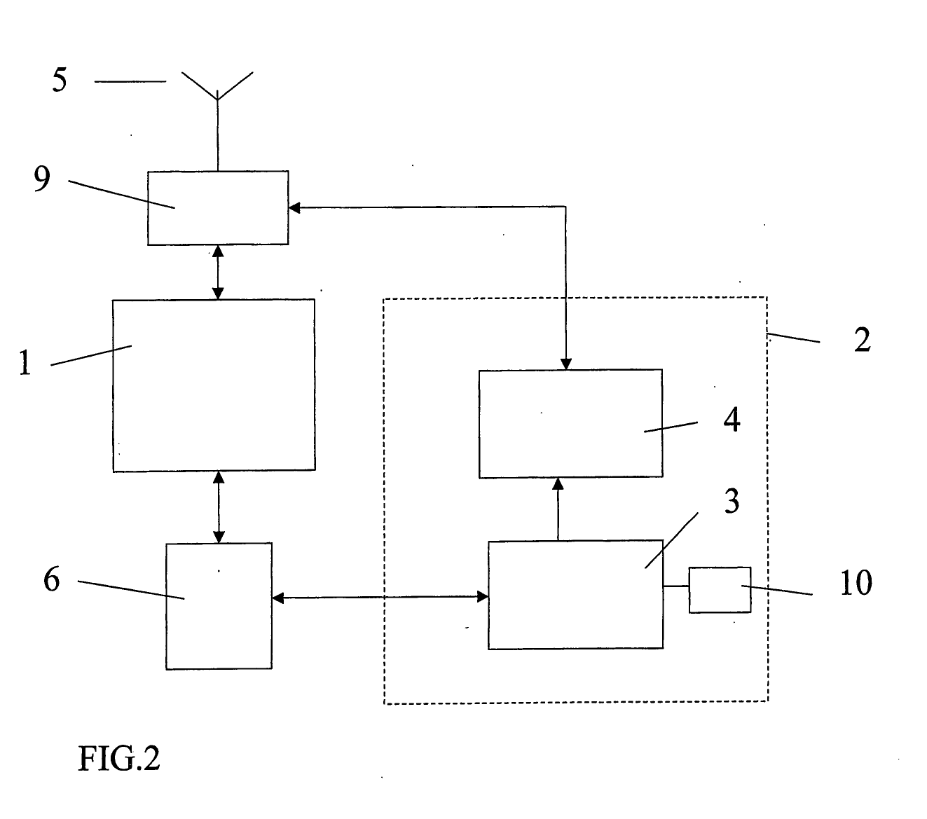

Shown in FIGS. 1 and 2 is a communications unit for identifying objects or persons. The unit includes a receiver/transmitter unit 1 in accordance with a Bluetooth system. The communications unit also includes a transponder 2 in accordance with a so called RFID system. The figures also show transponder specific circuits within the dotted frame.

According to the invention, the transponder 2 is integrated with the receiver/transmitter unit 1 in such a manner as to enable components associated with the receiver/transmitter unit to be used also for operation of the transponder 2, i.e., when the transponder receives a query signal and when it reflects and modulates said signal.

Thus, the invention relates to a communications system for communication with both an RFID system and a Bluetooth system.

The transponder 2 is of a kind known per se. It includes control logic 3 and an associated memory and modulator 4. The transponder is thus adapted to receive a query signal sent from a suitably known communicator, and therewith reflect the received signal while modulating the signal with a pulse train. Information relating to the pulse train is stored in the memory. The pulse train is received and decoded by the communicator. The modulated signal may contain various types of information. Each transponder will typically have a unique identity that is sent to the communicator in the aforesaid manner.

However, the transponder may also be designed to enable information to be written into the transponder memory, so that said information can be read-out from the memory later on, in the aforesaid manner. In this regard, the write signal is a modulated signal sent by the communicator. In the case of this embodiment, the control logic 3 includes a decoder, which functions to decode the signal received.

According to a highly preferred embodiment, the transponder 2 includes only one modulator 4, whereas the transponder is arranged in other respects to use, in operation, the antenna 5 of the receiver/transmitter unit 1, control circuit 6, and a battery (not shown) belonging to the Bluetooth arrangement 1. In the case of this embodiment, the function of the control logic 3 is thus included in the function of the control circuit 6.

According to a first embodiment of the invention, shown in FIG. 1, an electronic switch 7 is included between the common antenna 5 and the specific components of the receiver/transmitter unit 1 as well as the specific components of the transponder 2, respectively.

The switch 7 is controlled by a detector 8 positioned at the antenna 5, and it functions to detect whether a signal received by the antenna 5 is a Bluetooth signal or an RFID signal intended for the transponder 2. Upon completion of this detection, the signal received is sent either to the Bluetooth receiver/transmitter 1 or, alternatively, to the transponder 2.

The switch 7 is controlled by the control circuit 6 when transmitting from the communications unit.

When a transponder signal is received, the signal will either be reflected by the modulator 4 or, if it is a write signal, it will be decoded in the aforesaid manner and entered into the memory, depending on the design of the transponder.

When the signal received is a Bluetooth signal, a transmitter signal is created in the receiver/transmitter unit 1 and sent to the antenna 5.

According to a second embodiment of the invention, illustrated in FIG. 2, a power divider 9 is located between the common antenna 5 and the specific components of the receiver/transmitter unit 1 as well as the specific components of the transponder 2, respectively. In this case, the Bluetooth receiver/transmitter 1 and the transponder 2 both receive a signal at one and the same time. Either the Bluetooth receiver/transmitter 1 or the transponder 2 will send a signal in response to the signal received, depending on the type of received signal.

When the transponder is a read-only transponder, i.e., information can only be read from the transponder, it is beneficial in respect of both embodiments that the transponder 2 is provided with its own battery 10 for supplying power to the control logic 3 of the transponder.

Different embodiments with different degrees of integration between the Bluetooth arrangement and the transponder have been mentioned above.

According to one embodiment which is highly preferred in respect of certain applications, the sole transponder-specific component is the transponder modulator 4, which is adapted to modulate and reflect a received signal in the absence of a fresh supply of energy to the received signal. When the aforesaid power divider 9 is used, this embodiment enables the transponder 2 to function without the Bluetooth arrangement 1 being in operation.

It will be apparent that the present invention solves the problems mentioned in the introduction.

In one highly user-friendly application, a transponder can also be included in a mobile telephone designed for Bluetooth communication.

This design is particularly advantageous when the present communications unit is constructed so that the transponder will also function when the mobile telephone is switched-off in general. This means that the user can be identified without carrying a separate transponder.

A design in which Bluetooth and transponder are both integrated in a mobile telephone enables, e.g., the transponder to be used for identifying a user of a computer, or some other equipment equipped with Bluetooth, for making use of Bluetooth communication possible.

Although the invention has been described above with reference to a number of exemplifying embodiments, it will be obvious that the invention can be varied with respect to its constructive design.

The present invention shall not therefore be considered to be limited to said exemplifying embodiments, since these embodiments can be modified within the scope of the accompanying claims.

1. A communications unit for identifying objects or persons, said communications unit comprising: a transponder operable in accordance with a RFID communications system; a receiver/transmitter unit operable in accordance with a Bluetooth communications system; wherein the transponder includes a modulator and is interconnected with the receiver/transmitter unit to enable components associated with the receiver/transmitter unit to also be used for transponder operation.

2. A communications unit according to claim 1, wherein the transponder is operatively connected with an antenna, a control system, and a battery, each of which is operatively connected with the receiver/transmitter unit.

3. A communications unit according to claim 1, wherein the transponder includes a battery for supplying current to a transponder control logic circuit.

4. A communications unit according to claim 2, including a power divider positioned connected between the antenna and each of the receiver/transmitter unit and the transponder.

5. A communications unit according to claim 2, including an electronic switch connected between the antenna and each of the receiver/transmitter unit and the transponder.

6. A communications unit according to claim 5, wherein said switch is controlled by a detector when transmitting from the communications unit, and wherein the detector is operable to ascertain whether a signal received by the antenna is a Bluetooth signal or an RFID signal.

7. A communications unit according to claim 1, wherein a sole specific component of the transponder is a transponder modulator operable to modulate and to reflect a received signal in the absence of a supply of fresh energy to a received signal.
